(19) United States
(12) Patent Application Publication
(10) Pub. No.: US 2024/0264068 A1
(43) Pub. Date: Aug. 8, 2024

(54) LASERS FOR CONDENSATION PARTICLE COUNTERS

(71) Applicant: OpenAeros LLC, St. Paul, MN (US)

(72) Inventors: Aaron Michael Collins, Minneapolis, MN (US); Chia Hua M. Pang, St. Paul, MN (US); Rachel Andreasen, St. Paul, MN (US); Christopher Richard Saline Libby, St. Louis Park, MN (US); Louis Avery Goessling, Minneapolis, MN (US)

(21) Appl. No.: 18/590,748

(22) Filed: Feb. 28, 2024

Related U.S. Application Data
(63) Continuation-in-part of application No. 18/428,986, filed on Jan. 31, 2024.
(60) Provisional application No. 63/443,834, filed on Feb. 7, 2023.

(51) Int. Cl. G01N 15/1434; G01N 15/1404

(52) U.S. Cl. CPC G01N 15/1434; G01N 15/1404

(57) ABSTRACT

In general, some embodiments include an apparatus, as well as methods and systems thereof, that can detect particles using a condensation particle counter having a laser configured to produce a laser beam. The apparatus can also include a photodetector configured to detect light scattered from the laser beam after the beam hits a particle in a test fluid. More specifically, in some embodiments, the apparatus can detect particles using a fixed laser within the condensation particle counter. Also, in some embodiments, the apparatus can detect particles using a laser configured to produce a focused laser beam that is focused along at least two axes. And, more specifically, in some embodiments, the apparatus can detect particles using a fixed laser within the condensation particle counter that is configured to produce a focused laser beam that is focused along at least two axes.

### CROSS-REFERENCE TO RELATED APPLICATIONS

The present application claims the benefit of priority from U.S. patent application Ser. No. 18/428,986, filed on Jan. 31, 2024, and entitled “CONDENSATION PARTICLE COUNTERS”, which claims the benefit of priority from U.S. Provisional Patent Application Ser. No. 63/443,834, filed on Feb. 7, 2023, and entitled “Condensation Nucleation Particle Counter”, the entire disclosures of which applications are hereby incorporated herein by reference.

### FIELD

Generally, the present disclosure relates to techniques for detecting particles using lasers. Specifically, the present disclosure relates to techniques for detecting particles using lasers with condensation particle counters.

### BACKGROUND

Laser particle counters are known to count particles in an airstream as small as 300 to 500 nanometers (nm) as a consequence of the light scattering signal available for these particle sizes. The ability to measure particles smaller than 300 nm, which are often called ultrafine particles (UFP), is needed as there is mounting evidence that exposure to UFP's can result in endothelial dysfunction, vascular inflammation, and atherosclerosis. Thus, given these example issues, it would be beneficial to characterize airstreams with respect to the concentration of UFPs. This is just one example of the many technical problems solved by the technical solutions described herein.

### SUMMARY

In general, some embodiments include an apparatus, as well as methods and systems thereof, that can detect particles using a condensation particle counter having a laser configured to produce a laser beam. The apparatus can also include a photodetector configured to detect light scattered from the laser beam after the beam hits a particle in a test fluid. More specifically, in some embodiments, the apparatus can detect particles using a fixed laser within the condensation particle counter. Also, in some embodiments, the apparatus can detect particles using a laser configured to produce a focused laser beam, wherein the focused laser beam is focused along at least two axes. And, more specifically, in some embodiments, the apparatus can detect particles using a fixed laser within the condensation particle counter that is configured to produce a focused laser beam. In some cases, the beam diameter of the focused laser beam is smaller than the width or the diameter of the opening or the stream diameter of the stream of the test fluid as the laser beam intersects the stream.

In some examples, an apparatus includes a detection chamber and a conduit configured to convey a test fluid to the detection chamber. The apparatus also includes a nozzle at an end of the conduit including an opening and is configured to eject the test fluid into the detection chamber via the opening. The apparatus also includes a detection system configured to monitor at least one characteristic of the test fluid when it is ejected from the opening of the nozzle. And, the detection system, includes a laser, configured to produce a focused laser beam, and a photodetector, configured to detect light scattered from the focused laser beam after the beam hits a particle in the test fluid as the fluid is ejected from the opening of the nozzle. In some cases, the laser is a fixed laser configured to produce a laser beam in general that is not necessarily focused. And, in some cases, the laser is not fixed in that it can be adjusted in an operation of the apparatus. Also, in some examples, the laser is both a fixed laser and configured to produce a focused laser beam. In some examples, the laser is not necessarily fixed or configured to produce a focused laser beam; however, the location of the nozzle is adjustable, in an operation of the apparatus, to align the opening of the nozzle with the laser beam produced by the laser.

In some examples wherein the laser beam is focused, the opening of the nozzle is circular and the beam diameter of the focused laser beam is smaller than the diameter of the opening. In some examples wherein the laser is focused, the opening of the nozzle is oval and the beam diameter of the focused laser beam is smaller than the largest diameter of the opening. In some examples wherein the laser is focused, the opening of the nozzle is oval and the beam diameter of the focused laser beam is smaller than the smallest diameter of the opening.

In some examples wherein the laser beam is focused, the beam diameter of the focused laser beam is smaller than the largest width across the opening of the nozzle. Also, the beam diameter of the focused laser beam can be smaller than the smallest width across the opening of the nozzle. Also, in some examples, the beam diameter of the focused laser beam is smaller than the stream diameter of the stream of the test fluid as the laser beam intersects the stream. Also, in some examples, the beam cross-section area of the focused laser beam, at the intersection of the stream, is smaller than the cross-section area of the stream of the test fluid.

In some examples, the photodetector includes a lensless light scatter collection system, configured to receive the scattered light. And, in some cases, the lensless light scatter collection system is integrated with the photodetector and the apparatus. In some cases, the scattered light collection system is configured to use forward scattered light collection. And, in some examples, the azimuthal collection angles of the light collection are one or more values or in a range of degrees such as 6 to 45 degrees. In some examples, the photodetector includes a lensless scattered light collection system and an integrated beam stop.

In some examples, the detection system is configured to adjust the intensity of the laser beam based on the detection of scattered light by the photodetector. In some cases, the opening and at least another part of the nozzle is in the detection chamber. In some examples, the conduit configured to convey the test fluid to the detection chamber is coupled to a particle growth stage conduit that is upstream of the detection chamber.

In some examples wherein the laser is fixed, the location of the nozzle is adjustable to align the opening of the nozzle with the laser beam of the fixed laser. Also, in some examples, the location of the nozzle is adjustable via an eccentric mechanism including an attachment part attaching the nozzle to the eccentric mechanism and fixed to a rotating axle with the center or a midpoint of the attachment part offset from that of the axle. Also, in some examples, the attachment part is a portion of the nozzle.

These and other important aspects of the invention are described more fully in the detailed description below. The invention is not limited to the particular apparatuses and systems described herein. Other embodiments can be used and changes to the described embodiments can be made without departing from the scope of the claims that follow the detailed description. Within the scope of this application, it should be understood that the various aspects, embodiments, examples, and alternatives set out herein, and individual features thereof can be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

The present disclosure will be understood more fully from the detailed description given below and from the accompanying drawings of various example embodiments of the disclosure.

FIG. 1A illustrates a perspective view of a portion of a laser beam and a portion of a nozzle of a particle counter, in accordance with some known examples of prior art and in accordance with some embodiments of the present disclosure. FIG. 1B illustrates a cross-sectional view of the laser beam shown in FIG. 1A interacting with the nozzle exit of the nozzle shown in FIG. 1A.

FIG. 2A illustrates a perspective view of a portion of a focused laser beam and a portion of a nozzle of a particle counter, in accordance with some embodiments of the present disclosure. FIG. 2B illustrates a cross-sectional view of the focused laser beam shown in FIG. 2A interacting with the nozzle exit of the nozzle shown in FIG. 2A.

FIG. 3 illustrates a view of an example condensation particle counter with parts broken away to show parts in the interior of the counter, in accordance with some embodiments of the present disclosure.

FIG. 4 illustrates a view of another example condensation particle counter with parts broken away to show parts in the interior of the counter, in accordance with some embodiments of the present disclosure.

FIG. 5 illustrates a view of the example condensation particle counter shown in FIG. 3 with parts broken away to show parts in the interior of the counter and zoomed in on the nozzle of the counter to show an adjustment mechanism of the nozzle, in accordance with some embodiments of the present disclosure.

FIG. 6 depicts an illustrative flowchart of an example generation and outputting of an analog signal from a condensation particle counter to an example determination of the number of particles exiting the nozzle of the counter per unit time, in accordance with some embodiments of the present disclosure.

FIG. 7 illustrates an example method implemented by a computing system for determining the number of particles exiting a nozzle of a counter per unit time, in accordance with some embodiments of the present disclosure.

FIG. 8 illustrates a block diagram of example aspects of an example computing system, in accordance with some embodiments of the present disclosure.

### DETAILED DESCRIPTION OF THE DRAWINGS

Details of example embodiments of the invention are described in the following detailed description with reference to the drawings. Although the detailed description provides reference to example embodiments, it is to be understood that the invention disclosed herein is not limited to such example embodiments. But to the contrary, the invention disclosed herein includes numerous alternatives, modifications, and equivalents as will become apparent from consideration of the following detailed description and other parts of this disclosure.

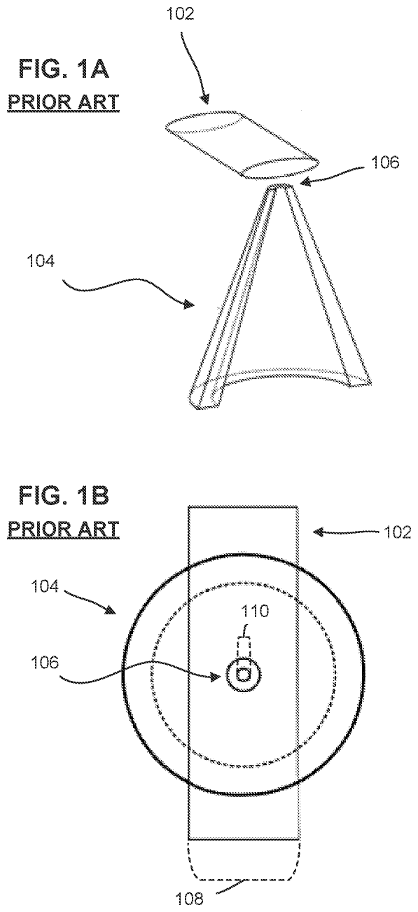

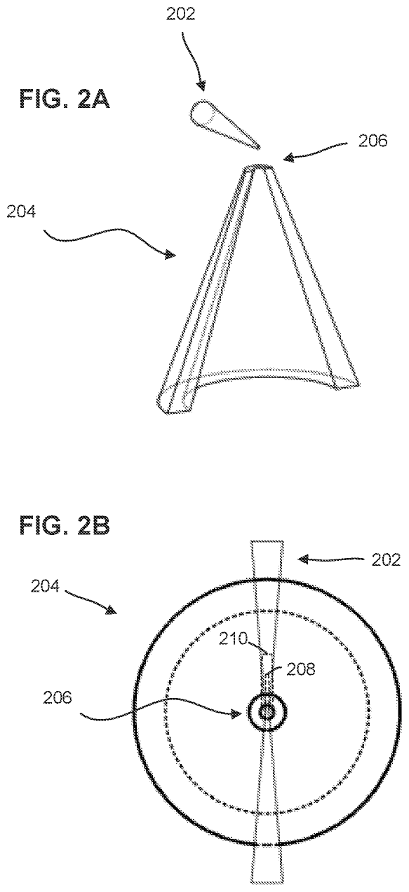

FIG. 1A illustrates a perspective view of a portion of a laser beam 102 and a portion of a nozzle 104 of a particle counter, in accordance with some known examples of the prior art and in accordance with some embodiments of the present disclosure. FIG. 1B illustrates a cross-sectional view of the laser beam 102 shown in FIG. 1A interacting with the nozzle exit 106 of the nozzle 104 shown in FIG. 1A. Whereas, FIG. 2A illustrates a perspective view of a portion of a focused laser beam 202 and a portion of a nozzle 204 of a particle counter, in accordance with some embodiments of the present disclosure. FIG. 2B illustrates a cross-sectional view of the focused laser beam 202 shown in FIG. 2A interacting with the nozzle exit 206 of the nozzle 204 shown in FIG. 2A. The focused laser beam 202 is an example of a two-axis focused laser beam. Whereas the laser beam 102 is actually a single-axis focused laser beam.

As shown, the width 108 of the laser beam 102 is greater than the width or diameter 110 of the nozzle exit 106. The laser beam 102 shown in FIGS. 1A and 1B is a single-axis focused beam for the purposes of this disclosure and it has a width 108 that is greater than the width or diameter 110 of the nozzle exit 106. Contrary to FIGS. 1A and 1B, FIGS. 2A and 2B show an example of a two-axis focused laser beam (e.g., see focused laser beam 202) in which the focused laser beam has a width (e.g., see width 208) that is less than the width or diameter 210 of the nozzle exit 206. Thus, the beam 202 is a focused laser beam or a two-axis focused laser beam for the purposes of this disclosure. With that said, the focused laser beam 202 is just one example of how a laser can be focused for the purposes of this disclosure. For example, in some example embodiments where the laser beam is focused, the opening of the nozzle is circular and the beam diameter of the focused laser beam is smaller than the diameter of the opening. Also, in some examples wherein the laser is focused, the opening of the nozzle is oval and the beam diameter of the focused laser beam is smaller than the largest diameter of the opening. Also, in some examples wherein the laser is focused, the opening of the nozzle is oval and the beam diameter of the focused laser beam is smaller than the smallest diameter of the opening.

It is to be understood, for the purposes of this disclosure, that any laser beam that is referred to herein as unfocused or not focused is actually a single-axis focused laser beam in that it is focused along one axis. And, it is to be understood, for the purposes of this disclosure, that any laser beam that is referred to herein as a “focused laser beam” is actually a two-axis or multiple-axis focused laser beam in that it is focused along multiple axes.

In some examples wherein the laser beam is focused, the beam diameter of the focused laser beam is smaller than the largest width across the opening of the nozzle (e.g., see width 208 and diameter 210 shown in FIG. 2B). Also, in some examples, the beam diameter of the focused laser beam can be smaller than the smallest width across the opening of the nozzle. Also, in some examples, the beam diameter of the focused laser beam is smaller than the stream diameter of the stream of the test fluid as the laser beam intersects the stream. Also, in some examples, the beam cross-section area of the focused laser beam, at the intersection of the stream, is smaller than the cross-section area of the stream of the test fluid.

FIGS. 1A, 1B, 2A, and 2B shows an example difference in optical beam paths between a single-axis focused laser beam of many known optical counters used within condensation particle counters (see FIGS. 1A and 1B) and a two-axis focused laser beam used of optical counters used within some of the novel condensation particle counters described herein (see FIGS. 2A and 2B). In some embodiments, an elliptical laser beam is used that is wider than the nozzle or the nozzle hole or exit and that has an aspect ratio such that the beam is relatively thin, obtained by the focus of the laser in only a single-axis. This reduction in beam thickness reduces the volume of optically illuminated particles and helps reduce the probability that two particles are in the laser beam at the same time, which is often called coincidence. The single-axis focused laser beam limits the possibility of a particle exiting the nozzle without intersecting the beam. With the single-axis focused beam, the beam is wide like a ribbon or sheet, and the nozzle opening providing a test fluid stream intersect in a region where the intensity is relatively uniform resulting in a scattered light signal that also is relatively uniform in amplitude.

With a two-axis focused laser beam, in some embodiments, circular beam is used and the beam is focused down in both directions such that a small and focused spot intersects the nozzle exit or hole. Using the focused beam results in a region with much higher intensity due to the small beam area, and the resulting beam width is now smaller than the nozzle diameter. Thus, with the focused beam, some of the particles may exit the nozzle without having passed through the laser beam. Or, such an occurrence is more likely using the two-axis focused beam compared to the single-axis focused beam. One advantage to the two-axis focused beam is the small spot size, and that it further reduces coincidence as the optically illuminated area is much smaller than a single-axis focused beam. In some embodiments, an elliptical beam can be focused and used with the counter. And, in some embodiments, a circular beam can be single-axis focused in that it is wider than the nozzle or the nozzle hole or exit.

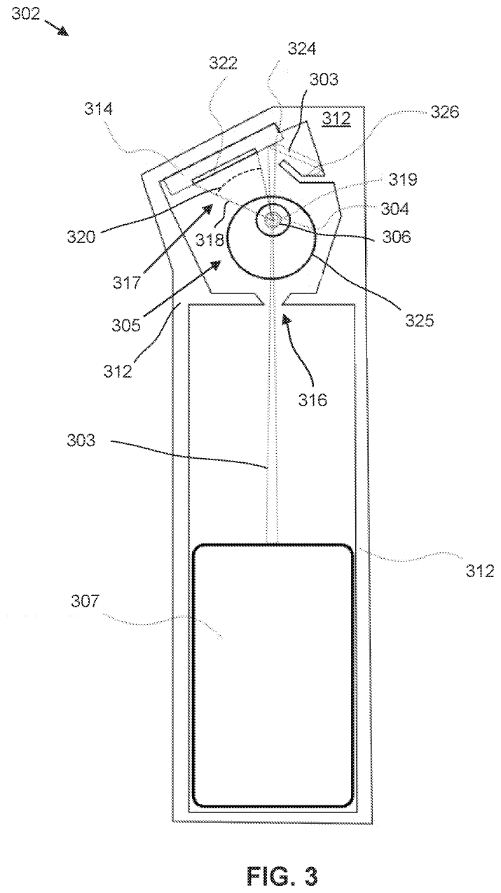

FIG. 3 illustrates a view of an example condensation particle counter 302 with parts broken away to show parts in the interior of the counter, in accordance with some embodiments of the present disclosure. The condensation particle counter 302 includes a nozzle 304 and a nozzle exit 306 (such as the nozzle exits shown in FIGS. 1A, 1 B, 2A, and 2B) as well as a two-axis focused laser beam 303 shown emitting from a laser module 307 (such as the focused beam shown in FIGS. 2A and 2B). The laser module 307 emits the laser beam 303 such that it is focused to a tight spot at a working distance from the end of the laser module. The condensation particle counter 302 also includes an optics housing 312 that holds at least the optical components of the counter 302 including holding the laser module 307, the nozzle 304, an eccentric adjustment mechanism 305, and a photodiode 314. In some embodiments, the housing 312 is pneumatically sealed relative to the ambient to ensure that any fluid flow in the optical system only comes from the nozzle exit 306. In some embodiments, the nozzle 304 and then the nozzle exit 306 are downstream of a conduit in a condenser portion of a condensation particle counter or a conduit providing a barrier fluid flow.

Referring back to the focused laser beam 303, the laser beam passes through an aperture 316 in the housing 312. In some examples, the aperture 316 is integrated into the housing 312 such that they are one part (e.g., one molded or fabricated part). The aperture 316 limits stray light from entering the scattered light collection area 317 of the counter 302. A focal point of laser of the laser module 307 is configured such that the beam emitted intercepts at the center of the exit 306 of the nozzle 304. Particles exiting the nozzle intersect the laser beam 303 and the intersection of the beam and the particles causes the beam to transform into scattered light 318. The scattered light 318 enters the scattered light collection area 317 after the intersection of the beam and the particles. As shown, the beam 303 and the nozzle exit 306 intersect at a beam waist 319 of the beam. The beam waist 319, in some embodiments, is the part of the beam that has a narrower width than the width of the nozzle or the nozzle hole or exit. The beam waist 319 can include a focus point of the laser beam 303. The scattered light 318 can be emitted from the intersection of the beam 303 and the exit 306 at a forward scattered angle 320. The forward scatter angle 320 can include a group of angles, such as a group of angles ranging between seven and thirty degrees in some examples, relative to the collection of the light 318 by the photodiode 314. An active area 322 of the photodiode 314 captures the scattered light 318. After the scattered light 318 is received by the active area 322 of the photodiode 314, the corresponding signal derived from the capturing of the light can be amplified and processed, such as processed by at least an analog-to-digital converter (ADC).

In addition to the scattered light 318, the remainder of the light from the beam 303 continues past the nozzle and strikes a first surface reflector 324. The first surface reflector 324, as shown in FIG. 3, is an un-active area of the photodiode 314. The inactive area of the photodiode 314 can be a part of or include the housing of the photodiode. The first surface reflector 324 is arranged to reflect the beam 303 into a beam stop 326. The beam stop 326 is configured to receive the reflection of the light from the non-active area of the photodiode or the reflector 324 such that all reflection from the surface remains within the beam stop and cannot exit the beam stop. This beam stop 326 is used in the counter 302 to prevent stray light from reflecting inside the housing 312 and into the scattered light collection area 317. This way the reflected light that is not scattered at the nozzle exit 306 by the flowing particles is not collected by the active area 322 of the photodiode 314. Stray light can limit the amplification levels of the photodiode 314, as a constant input light represents a DC bias in the amplification circuit and can limit the dynamic range of the amplifier circuit. The internal reflections within the beam stop 326 can also be reduced in amplitude by the use of optically absorbing material in some embodiments. Also, in some examples, the reflector 324 includes an absorbing material for the wavelength of the laser beam 303.

In some embodiments, the housing 312 includes a simple plastic housing fabricated from 3D printing. In some examples, the housing 312 fully integrates the features of the counter 302 necessary to hold the components internal to the housing such as the laser module 307, the nozzle 304 and nozzle holder 325 with the eccentric adjustment mechanism 305, and the forward scattered light collection optics board that includes the photodiode 314. The counter 302 as a system is designed to be airtight in some examples. This ensures no outside particles enter into the system and only the primary flow from streamed from the nozzle 304 enters the counter 302. This facilitates the optical counting of particles as they exit nozzle 304 after being grown in a prior condensation growth stage. In some examples, the system of the counter 302 is designed with considerations that typically come with a condensation particle counter including the capability to operate with a flow of air exiting the condensation growth stages that is at near saturation vapor point of the condenser portion of the growth stage of the particles.

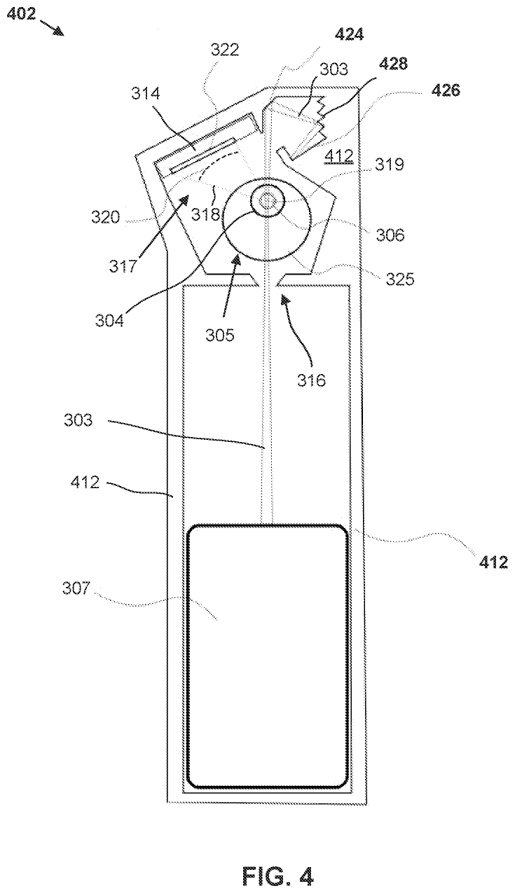

FIG. 4 illustrates a view of another example condensation particle counter 402 with parts broken away to show parts in the interior of the counter, in accordance with some embodiments of the present disclosure. The counter 402 shares similar parts to the counter 302, except the housing 412 is configured differently from housing 312 in that it holds the photodiode 314 differently and includes the first surface reflector 424 instead of the first surface reflector being part of an un-active area of the photodiode. Also, as shown the beam stop 426 of the counter 402 has a different design from the beam stop 326 of the counter 302. The beam stop 426 is integrated into the housing 412 and is shown including a primary reflecting surface 428 that is integrated into the housing too. This primary reflective surface 428 can include a light-absorbing material too. Additionally, the surfaces within the beam stop 426 (as well as the beam stop 326) can be coated with such a material to ensure that further reflections and any scattered light are further attenuated to reduce scattered light from entering the viewing area of the photodiode (e.g., see scattered light collection area 317). The design of the beam stop 426 may also include topography and geometry that further help reduce internal reflections. As shown, this can include a saw-tooth-like profile at the primary reflective surface 428, or a variety geometry to ensure incoming light is captured. Such features can also be used by the beam stop 326.

Similarly, in some embodiments, the housing 412 includes a simple plastic housing fabricated from 3D printing. In some examples, the housing 412 fully integrates the features of the counter 402 necessary to hold the components internal to the housing such as the laser module 307, the nozzle 304 and nozzle holder 325 with the eccentric adjustment mechanism 305, and the forward scattered light collection optics board that includes the photodiode 314. Similarly, the counter 402 as a system is designed to be airtight in some examples. This ensures no outside particles enter into the system and only the primary flow from streamed from the nozzle 304 enters the counter 402. This facilitates the optical counting of particles as they exit nozzle 304 after being grown in a prior condensation growth stage. In some examples, the system of the counter 402 is designed with considerations that typically come with a condensation particle counter including the capability to operate with a flow of air exiting the condensation growth stages that is at near saturation vapor point of the condenser portion of the growth stage of the particles.

In some examples, the nozzle 304 and the beam 303 may not align such that the beam waist 319 and particles released from the nozzle exit 306 intersect. To overcome such misalignment, the nozzle 304 is attached to the nozzle holder 325 which is part of the eccentric adjustment mechanism 305. Rotation of part of the eccentric adjustment mechanism 305 results in an arc sweep of the nozzle 304. Thus, the nozzle 304 can be adjusted by the eccentric adjustment mechanism 305 to intercept the laser beam 303 by rotating the nozzle holder 325 via the eccentric adjustment mechanism.

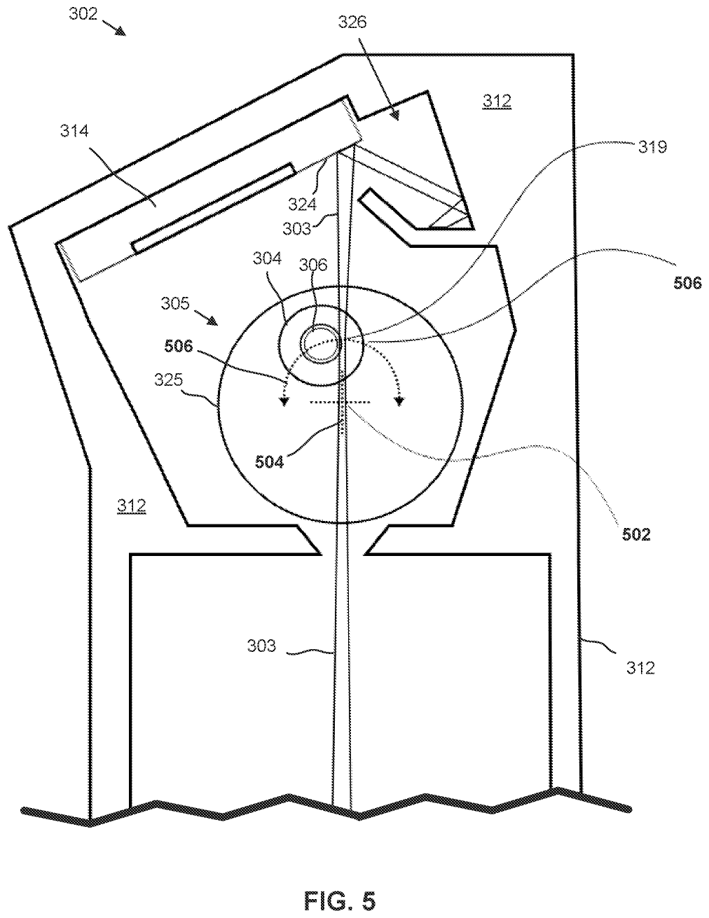

FIG. 5 illustrates a view of the condensation particle counter 302 with parts broken away to show parts in the interior of the counter and zoomed in on the nozzle 304 of the counter to show an adjustment mechanism 305 of the nozzle, in accordance with some embodiments of the present disclosure.

The center 502 of the adjustment mechanism 305 and the nozzle holder 325 lies on the laser beam axis 504 of the laser beam, and an angular or positional error can be adjusted out by a nozzle motion path 506 resulting from the rotation about the center 502 of the nozzle holder 325. The rotation and adjustment of the nozzle 304 ensures optical alignment between the nozzle exit 306 and the beam 303. The alignment of the laser beam 303 to the nozzle 304 is critical in the counters 302 and 402 since the particles exiting the nozzle must intersect the laser beam to scatter the light of the beam to be captured by the photodiode 314 and then the corresponding signal eventually being transformed into information including a particle count.

In general, some embodiments include an apparatus, as well as methods and systems thereof, that can detect particles using a condensation particle counter (e.g., see counter 302 or 402) having a laser (e.g., see laser module 307) configured to produce a laser beam (e.g., see laser beam 303). The apparatus can also include a photodetector (e.g., see photodiode 314) configured to detect light scattered from the laser beam after the beam hits a particle in a test fluid. More specifically, in some embodiments, the apparatus can detect particles using a fixed laser within the condensation particle counter (e.g., see laser module 307). Also, in some embodiments, the apparatus can detect particles using a laser configured to produce a focused laser beam (e.g., see focused laser beam 303), wherein the focused laser beam is focused along at least two axes. And, more specifically, in some embodiments, the apparatus can detect particles using a fixed laser within the condensation particle counter that is configured to produce a focused laser beam (e.g., see laser module 307 and focused laser beam 303). In some cases, the beam diameter of the focused laser beam is smaller than the width or a diameter of the opening or the stream diameter of the stream of the test fluid as the laser beam intersects the stream (e.g., see beam waist 319 which is narrower than the nozzle exit 306).

In some examples, an apparatus includes a detection chamber (e.g., see the scattered light collection area 317 and the immediate surrounding area within the housing 312) and a conduit configured to convey a test fluid to the detection chamber (e.g., see nozzle 304 which is at the downstream end of a conduit configured to convey a test fluid to the detection chamber). The apparatus also includes a nozzle (e.g., see nozzle 304) at an end of the conduit including an opening (e.g., see nozzle exit 306) and is configured to eject the test fluid into the detection chamber via the opening. The apparatus also includes a detection system configured to monitor at least one characteristic of the test fluid when it is ejected from the opening of the nozzle. And, the detection system, includes a laser (e.g., see laser module 307), configured to produce a focused laser beam (e.g., see laser beam 303), and a photodetector (e.g., see photodiode 314), configured to detect light scattered from the focused laser beam after the beam hits a particle in the test fluid as the fluid is ejected from the opening of the nozzle. In some cases, the laser is a fixed laser configured to produce a laser beam in general that is not necessarily focused. And, in some cases, the laser is not fixed in that it can be adjusted in an operation of the apparatus. Also, in some examples, the laser is both a fixed laser and configured to produce a focused laser beam. In some examples, the laser is not necessarily fixed or configured to produce a focused laser beam; however, the location of the nozzle is adjustable, in an operation of the apparatus, to align the opening of the nozzle with the laser beam produced by the laser (e.g., see eccentric adjustment mechanism 305, nozzle holder 325, center 502 of the adjustment mechanism 305, the laser beam axis 504 of the laser beam 303, and the nozzle motion path 506 shown in FIG. 5).

In some examples, the photodetector includes a lensless light scatter collection configured to receive the scattered light (e.g., see photodiode 314). And, in some cases, the lensless light scatter collection is integrated with the photodetector and the apparatus. In some cases, the light collection system is configured to use forward scattered light collection. And, in some examples, the azimuthal collection angles of the light collection are 6 to 45 degrees. In some examples, the photodetector includes a lensless scattered light collection system, first surface reflector, and an integrated beam stop.

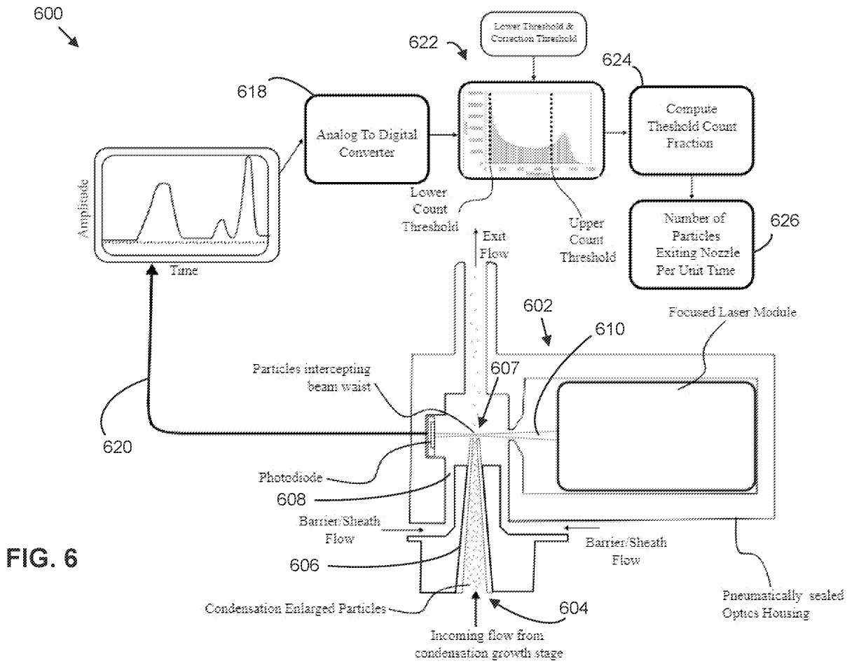

In some examples, the detection system is configured to adjust the intensity of the laser beam based on the detection of scattered light by the photodetector. In some cases, the opening and at least another part of the nozzle is in the detection chamber. In some examples, the conduit configured to convey the test fluid to the detection chamber is coupled to a particle growth stage conduit that is upstream to the detection chamber (e.g., see optical counter portion 602 and the incoming flow of particles at flow 604 of the illustrative flowchart 600 depicted in FIG. 6).

In some examples wherein the laser is fixed, the location of the nozzle is adjustable to align the opening of the nozzle with the laser beam of the fixed laser (e.g., see the laser module 307 and the nozzle 304 shown in FIGS. 3 and 4). Also, in some examples, the location of the nozzle is adjustable via an eccentric mechanism including an attachment part attaching the nozzle to the eccentric mechanism and fixed to a rotating axle with the center or a midpoint of the attachment part offset from that of the axle (e.g., see eccentric adjustment mechanism 305, nozzle holder 325, center 502 of the adjustment mechanism 305, the laser beam axis 504 of the laser beam 303, and the nozzle motion path 506 shown in FIG. 5). Also, in some examples, the attachment part is a portion of the nozzle.

In some embodiments, in a condensation particle counter (such as counter 302 or 402), the counter uses a specially designed growth section to aerosol particles from their original size of 10-1000 nm(0.01-1 um) to 5000-10,000 nm(5-6 um). This growth mechanism is used, because traditional optical detection of particles by light scattering has a rough scaling factor of dp\hat{ }4 power, meaning the scattered light intensity for a 100 nm particle is roughly 1/10,000th of that of a 1 um particle. Thus the only practical way to optically detect a particle that is 10 nm in diameter, is to enlarge enough to easily optically detect it. This is done using condensation to grow the particles, which the initial state of a particle acts as seed nuclei to the condensation growth process. Once the particles have grown to sufficient size they are passed into the optical counting portion of the system. The optical counting device of the system can use forward light scattering for the optical detection of particles, due to the larger forward light scattering lobe of particles. To generate the light scattering signal, a focused laser beam is formed from a laser diode, and is passed over a nozzle (e.g., see laser module 307 and nozzle 304). The nozzle acts to both physically constrain the particles to a much smaller region, allowing for the final laser beam width to be smaller and at a higher intensity, and also has the effect of accelerating the particles so that they are further separated in distance in an axial direction corresponding to the beam helping ensure only one particle at time passes through the beam.

In some example systems, the forward light scattering collection or capturing uses a pair of large aspheric lenses, with a focal location set at the intercept of the laser beam and nozzle. The area in which the aspheric collection and laser beam area is often called the viewing volume, and represents the area in which particle scattered light can be collected. To ensure a uniform signal from the scattered light the laser beam is typically much wider than the nozzle (e.g., see FIGS. 1A and 1 B). In such cases, the laser beam has a Gaussian beam profile to ensure a relatively uniform intensity and only 10% of the beam width is often used; thus, for example, for a nozzle that may be 0.35 mm in diameter, the laser beam width(1/e\hat{ }2) may be 1.3 mm. This use of a wide beam, such as shown in FIGS. 1A and 1B, provides a relatively uniform signal at the tradeoff for beam intensity. In such examples and others, in the axial direction, the beam is focused down in terms of thickness, which has the benefits of both increasing the intensity and reducing the transit time into the beam to reduce the probability of more than one particle being present in the beam, often called coincidence. Overall, this design functions well but requires a significant number of components including precision alignment features to align the laser diode to the beam shaping optics and also to ensure that the laser beam passes over the nozzle. Precision assembly is also required to ensure that the beam stop, which prevents the laser beam from shining directly into the photodiode that collects the scatted light. The large lenses, typically of an aspheric type for the scattered light collection, can both be expensive but also must have good alignment to the nozzle and viewing volume to ensure the scattered light is collected within the collection angles of the optics. This all adds up to many precision machined components, precision assembly steps to ensure alignment, and this all adds to the considerable cost associated with such designs.

In some other example systems, such as in lower-cost optical counters used outside of condensation particle counters, take a different approach to particle detection. The use of low cost and focused laser beam modules can be used along with an integrated beam stop to produce a high-intensity focused beam design. In some of such examples, a 90-degree scattered light collection can be used due to the different requirements of a simple optical particle counter. However, in such simple designs, since a nozzle may not be used, the electronics required to amplify the signal may have much fewer bandwidth limitations when compared to the high speed of the typical condensation particle counter. Thus, the use of focused beams to get high intensity at the focus area provides a technical way of eliminating a wide range of scattered light collection optics in a particle counter design.

Some optics systems disclosed herein, such as the ones shown in FIGS. 3 and 4, provide for the optical counting of particles as they exit a nozzle of a condensation particle counter. Such a system is designed with considerations that typically come with a particle counter including the capability of it to work with a flow of air exiting the condensation growth stages that is at near saturation vapor point of the condenser portion of the growth stage. In such systems, such as the systems shown in FIGS. 3 and 4, many of the shortcomings and design challenges are overcome in the attempt to make a device for lensless light scattering collection. Large aspheric collection lenses provide a significant amount of scattered light collection, and simply removing them from the system and using a large format photodiode alone would not have enough scattered light to be compatible with a high-speed amplification circuit. To overcome this, the amount of scattered light generated must be significantly increased. One way to do this is to increase the intensity of the light in which the particles intersect the laser beam (e.g., see the focused beams of FIGS. 2A, 2B, 3, 4, and 5). To do this, the laser providing the laser must use a module for the generation of a focused laser beam that can provide a beam with a spot size of 0.035×0.035 mm (in contrast to typical designs that would have 1.3 mm×0.035 mm spot size). This increases the beam intensity; and thus, scattered light intensity is increased as well. In some cases, the scattered light intensity is increased by a magnitude of fifty times that of a single-axis focused beam. This significant increase in scattered light allows for the removal of the lenses (which can be very costly) and transition to a simple flat photodiode to collect the forward scattered light (which is shown in the counters 302 and 402).

Some example systems use raw laser diodes and then discrete optic components to generate the desired laser beam profile. This has resulted in complex alignment mechanics. In some embodiments, to avoid complications, the optics system uses a preassembled laser drive module that includes lenses and is integrated within the sealed housing of the counter (e.g., see counters 302 and 402). Some example counters are sealed to the inner flow cavity to prevent particles from entering into the optics system and contaminating them. To improve upon such a design, the laser module in some embodiments is sealed into the housing with no seals between the particle flow coming out of the nozzle and the optics of the system. In such examples, it can be useful to use a sheath or bypass flow, which acts to reduce the vapor pressure of the final mixture below the saturation point and also acts as a barrier to prevent particles from floating around in the optics system and depositing on components of the optics system (e.g., see the second fluid conduit 132 in fluid communication with the detection chamber 102—which is carrying a barrier fluid 134 and is independent of the first fluid conduit 106 that carries the test fluid—illustrated in FIG. 1 of U.S. patent application Ser. No. 18/428,986, filed on Jan. 31, 2024, and entitled “CONDENSATION PARTICLE COUNTERS”, the entire disclosure of which application is hereby incorporated herein by reference).

In some embodiments, the use of a laser module along with the less complex system design has enabled a counter that does not require difficult laser alignment. In the designs shown in FIGS. 3, 4, and 5, the housings can be 3D printed all in one piece and no alignment step (or difficult laser alignment) is needed to align the beam with the beam stop. The beam stop can use the edge of the photodiode packaging as a first surface reflector, as shown with the counter 302, in which the beam is then reflected into an integrated beam stop where the internal reflection within the beam stop prevents the light from ever exiting the beam stop. The beam stop can also be fabricated into the same portion of the housing that holds the laser and provides the internal flow into the optics chamber of the particle counter.

In some examples, where misalignment sometimes occurs, the nozzle providing the stream of particles can be attached to a part that can be rotated on an eccentric path, so that the nozzle can be rotated to bring into the intersection of the laser beam (e.g., see counters 302 and 402 as well as the alignment mechanism emphasized in FIG. 5). In some examples, using the particle count and amplitude of scattered light pulses allows for alignment to occur. As the nozzle is rotated, the recorded number increases as the laser begins to intercept the nozzle, and the change in concentration flattens out as the flow of particles sweeps across the beam and then falls off again if the alignment is off. Such a design can provide for an automated process, where the alignment does not require manual adjustment. Feedback from the counter counting the particles can provide for enhancing the alignment of the nozzle with the laser beam.

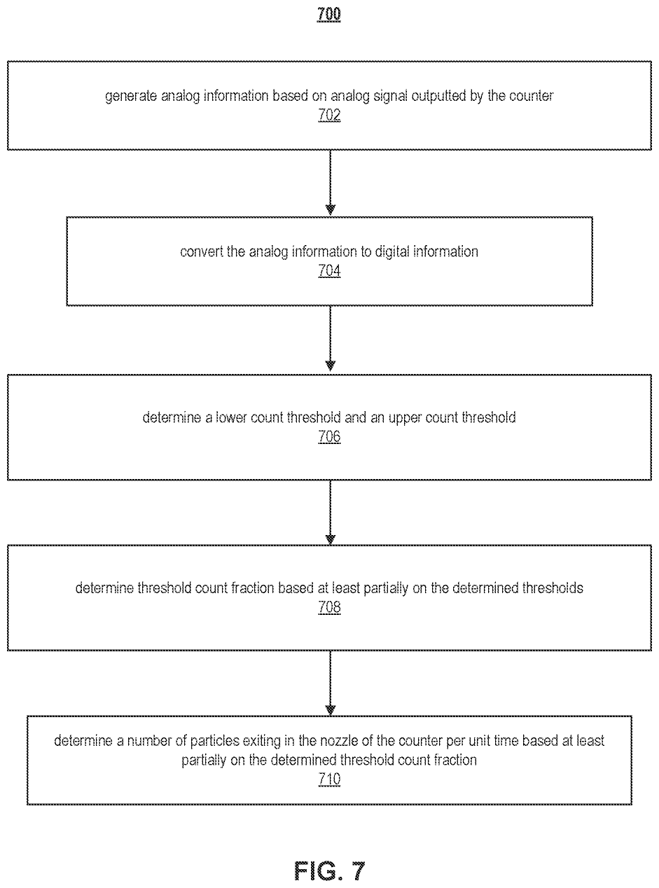

In some examples, a challenge with using a particle counter where the laser beam has a width that is narrower than the width of the nozzle or nozzle exit, and thus the trajectory of particles, is that because the laser beam includes a Gaussian distribution of light some fraction of particles only hit the edge of the beam resulting in a scattered light signal that is smaller than if the same particle had intercepted the middle portion of the laser beam. This means that a fraction of the particles exiting at the exit of the nozzle correspond with no scattered light and that there is a distribution of scattered light intensity. In designs where the beam is not focused, and in which the laser is much wider than the nozzle exit, the distribution of pulse heights corresponds with only a very small range corresponding to the small variation of laser beam intensity that occurs across the nozzle exit. To overcome the challenge of using a focused laser beam, a correction method can be used (e.g., see the operations shown in FIGS. 6 and 7). The correction method can be used in a way in which each particle's laser-scattered light pulse is collected, the peak of the intensity is determined, and a distribution of pulse amplitude is generated. Then, two threshold levels are used to determine which fraction of particles lie above and below these thresholds, which can be referred to as the threshold count ratio. Because of the Gaussian distribution of the focused laser, it is possible to compute which fraction of the particles were counted based on the threshold count ratio. The process flow for this method includes capturing the raw signal of the scattered light as particles traverse the beam, digitizing the captured signal using at least an analog-to-digital converter, and then computing the peak of the signal. Then, the method can include aggregating signal peak information on a time basis using the produced distribution to compute the threshold count ratio as well as using the threshold count ratio and an empirically determined model to compute a true count of particles exiting the nozzle.

Specifically, FIG. 6 depicts an illustrative flowchart 600 that starts with an example generation and outputting of an analog signal produced from the light collection of a photodiode of a condensation particle counter, such as the photodiode 314 of counter 302 or 402. And, the flowchart 600 ends with an example determination of the number of particles exiting the nozzle of the counter per unit time.

As shown in FIG. 6, an optical counter portion 602 is in fluid communication with the growth stage of a condensation particle counter (see the incoming flow of particles at flow 604). Particles that have been enlarged via condensation growth pass through a nozzle 606 which both constrains the particles into a smaller area and accelerates them (e.g., also see nozzle 304 shown in FIGS. 3 to 5). This increases the physical spacing between particles and helps reduce the probability that more than one particle is in the laser beam path simultaneously. In the design shown in FIG. 6, a barrier flow is introduced into the optics system at input 608, which reduces the vapor pressure of the working fluid used by the condensation growth stage and prevents condensation of the working fluid in the optics housing by diluting the vapor. The laser module, nozzle 606, and the photodiode are all contained within pneumatically sealed optics housing similar to the design shown in FIGS. 3 to 5 and such that the only inflows into the optics system are those of the barrier flow at input 608 and incoming flow from the condensation growth stage via the nozzle 606 and the exit of the nozzle 607 (e.g., also see the second fluid conduit 132 in fluid communication with the detection chamber 102—which is carrying a barrier fluid 134 and is independent of the first fluid conduit 106 that carries the test fluid—illustrated in FIG. 1 of U.S. patent application Ser. No. 18/428,986, filed on Jan. 31, 2024, and entitled “CONDENSATION PARTICLE COUNTERS”, the entire disclosure of which application is hereby incorporated herein by reference).

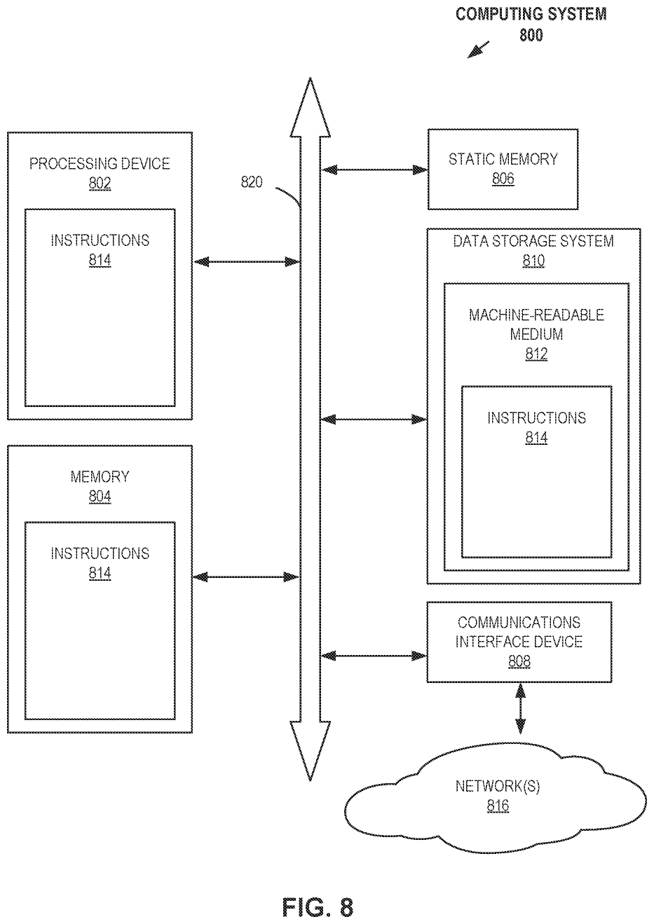

Particles exiting the nozzle 606 will intersect the focused laser beam 610 at its narrowest point (or at the waist of the focused beam), which results in the highest optical flux density and the highest intensity as well as an increased amount of scattered light as the particles traverse the beam at the exit of the nozzle 607. The scattered light (such as scatter light 318 shown in FIGS. 3 and 4) is captured by the photodiode and then the corresponding signal from the captured light is amplified and fed into an analog to a digital converter 618 via operation 620 (which can be implemented by a signal amplification circuit or by a computing system such as the one illustrated in FIG. 8, or a combination thereof depending on the embodiment).

Next, after the conversion by the digital converter 618, a computing system, such as the computing system 800 depicted in FIG. 8, determines the peak amplitude of the pulses along with pulse width and logs and aggregates such parts of the converted signal over a defined time interval. The resulting data, determined and aggregated by the computing system, includes a distribution of pulse amplitude. The distribution of the pulse amplitude can vary significantly because the laser beam is smaller than the nozzle and some particles do not intercept the focused laser beam, some partially intercept the beam but give lower scattered light intensity, and some particles intercept the beam at peak intensity of the beam and give the highest level of scattered light. This also results in a fraction of particles that exit the nozzle in which there is no scattered light as they do not traverse the beam, and some in which the captured scattered light is not sufficient to be seen over the optical and electronic noise in the optical system of portion 602. However, this fraction of missed counts can be corrected using computing operations (e.g., see operations of method 700 depicted in FIG. 7) implemented by a computing system such as the computing system 800 shown in FIG. 8.

The computing operations can use the collected and digitized data from converter 618, operation 620, and derivatives thereof (which can include information on maximum pulse amplitude) and use a correction factor to correct the fraction of missed counts of particles. A two-level discriminator or threshold generator, which is implemented by the computing system, is applied to the data at operation 622 and a summation of all counts above or below selected thresholds is computed. The first level, the lower count threshold, is derived from the sum of all counts that have a peak amplitude under a lower threshold level. The second level computed is derived from the sum of all peak amplitudes above the higher threshold level, called the upper count threshold. In such examples, a correction is applied in which a predetermined correction is used to account for missed particles using the threshold count ratio—which can be a ratio of the upper count threshold to the lower count threshold (referred to in the drawings as the threshold count fraction). But, first, the ratio is determined at operation 624. The corrected count, derived from the ratio, for an estimated true number of particles having exited the nozzle, is determined at operation 626. Then, in some examples, the estimated true number of particles can be used to calculate the count rate. Also, given known flow rates, the computing system can determine an estimated true concentration of particles present in the sample fluid. Besides a computing system, such as system 800, the operations 620, 622, and 624 can be implemented by a set of comparators and simple counters, such that the two levels are summed.

FIG. 7 illustrates an example method 700 implemented by a computing system for determining the number of particles exiting a nozzle of a counter per unit time, in accordance with some embodiments of the present disclosure. The method 700 is a computer-implemented method and, at step 702, commences with generating analog information based on analog signal outputted by the counter (e.g., see the output of optical counter portion 602 shown in FIG. 6). At step 704, the method 700 continues with converting the analog information to digital information(e.g., see operation 620 shown in FIG. 6). At step 706, the method 700 continues with determining a lower count threshold and an upper count threshold (e.g., see operation 622). At step 708, the method 700 continues with determining a threshold count fraction based at least partially on the determined thresholds (e.g., see operation 624). At step 710, the method 700 continues with determining the number of particles exiting in the nozzle of the counter per unit of time based at least partially on the determined threshold count fraction (e.g., see operation 626).

FIG. 8 illustrates example aspects of an example computing system 800, in accordance with some embodiments of the present disclosure. FIG. 8 illustrates parts of the computing system 800 within which a set of instructions, for causing the machine to perform any one or more of the methodologies discussed herein, can be executed (e.g., see operations of the steps of method 700 as well as operations of converter 618 and operations 620, 622, 624, and 626 of flowchart 600). In some embodiments, the computing system 800 can correspond to a host system that includes, is coupled to, or utilizes memory or can be used to perform the operations of a controller. In alternative embodiments, the machine can be connected (e.g., networked) to other machines in a LAN, an intranet, an extranet, and/or the Internet. The machine can be a personal computer (PC), a tablet PC, a set-top box (STB), a Personal Digital Assistant (PDA), a cellular telephone, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computing system 800 includes a processing device 802, a main memory 804 (e.g., read-only memory (ROM), flash memory, dynamic random-access memory (DRAM), etc.), a static memory 1206 (e.g., flash memory, static random-access memory (SRAM), etc.), and a data storage system 810, which communicate with each other via a bus 820. The processing device 802 represents one or more general-purpose processing devices such as a microprocessor, a central processing unit, or the like. More particularly, the processing device can be a microprocessor or a processor implementing other instruction sets, or processors implementing a combination of instruction sets. The processing device 802 can also be one or more special-purpose processing devices such as an application-specific integrated circuit (ASIC), a field programmable gate array (FPGA), a digital signal processor (DSP), a network processor, or the like. The processing device 802 is configured to execute instructions 814 for performing the operations discussed herein. The computing system 800 can further include a communications interface device 808 to communicate over one or more LAN/WAN networks 816.

The data storage system 810 can include a machine-readable storage medium 812 (also known as a computer-readable medium) on which is stored one or more sets of instructions 814 or software embodying any one or more of the methodologies or functions described herein (e.g., see operations of the steps of method 700 as well as operations of converter 618 and operations 620, 622, 624, and 626 of flowchart 600). The instructions 814 can also reside, completely or at least partially, within the main memory 804 and/or within the processing device 802 during execution thereof by the computing system 800, the main memory 804 and the processing device 802 also constituting machine-readable storage media. While the machine-readable storage medium 812 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that causes the machine to perform any one or more of the methodologies of the present disclosure (e.g., see operations of the steps of method 700 as well as operations of converter 618 and operations 620, 622, 624, and 626 of flowchart 600). The term “machine-readable storage medium” shall accordingly be taken to include, but not be limited to, solid-state memories, optical media, and magnetic media.

While the invention has been described in conjunction with the specific embodiments described herein, it is evident that many alternatives, combinations, modifications, and variations are apparent to those skilled in the art. Accordingly, the example embodiments of the invention, as set forth herein are intended to be illustrative only, and not in a limiting sense. Various changes can be made without departing from the spirit and scope of the invention.

What is claimed is:

1. An apparatus, comprising:
a detection chamber;
a conduit configured to convey a test fluid to the detection chamber;
a nozzle at an end of the conduit comprising an opening and configured to eject the test fluid into the detection chamber via the opening; and
a detection system configured to monitor at least one characteristic of the test fluid when it is ejected from the opening of the nozzle, and the detection system, comprising:
a laser configured to produce a focused laser beam, wherein the focused laser beam is focused along at least two axes; and
a photodetector configured to detect light scattered from the focused laser beam after the beam hits a particle in the test fluid as the fluid is ejected from the opening of the nozzle.

2. The apparatus of claim 1, wherein the opening of the nozzle is circular, and wherein the beam diameter of the focused laser beam is smaller than the diameter of the opening.

3. The apparatus of claim 1, wherein the opening of the nozzle is oval, and wherein the beam diameter of the focused laser beam is smaller than the largest diameter of the opening.

4. The apparatus of claim 1, wherein the opening of the nozzle is oval, and wherein the beam diameter of the focused laser beam is smaller than the smallest diameter of the opening.

5. The apparatus of claim 1, wherein the beam diameter of the focused laser beam is smaller than the largest width across the opening of the nozzle.

6. The apparatus of claim 1, wherein the beam diameter of the focused laser beam is smaller than the smallest width across the opening of the nozzle.

7. The apparatus of claim 1, wherein the beam diameter of the focused laser beam is smaller than the stream diameter of the stream of the test fluid as the laser beam intersects the stream.

8. The apparatus of claim 1, wherein the beam cross-section area of the focused laser beam, at the intersection of the stream, is smaller than the cross-section area of the stream of the test fluid.

9. The apparatus of claim 1, wherein the photodetector comprises a lensless light scatter collection system.

10. The apparatus of claim 1, wherein the opening and at least another part of the nozzle are in the detection chamber.

11. An apparatus, comprising:
a detection chamber;
a conduit configured to convey a test fluid to the detection chamber;
a nozzle at an end of the conduit comprising an opening and configured to eject the test fluid into the detection chamber via the opening; and
a detection system configured to monitor at least one characteristic of the test fluid when it is ejected from the opening of the nozzle, and the detection system, comprising:
a fixed laser configured to produce a laser beam; and
a photodetector configured to detect light scattered from the laser beam after the beam hits a particle in the test fluid as the fluid is ejected from the opening of the nozzle.

12. The apparatus of claim 11, wherein the location of the nozzle is adjustable to align the opening of the nozzle with the laser beam of the fixed laser.

13. The apparatus of claim 12, wherein the location of the nozzle is adjustable via an eccentric mechanism.

14. The apparatus of claim 13, wherein the eccentric mechanism comprises an attachment part attaching the nozzle to the eccentric mechanism and fixed to a rotating axle with the center or a midpoint of the attachment part offset from that of the axle.

15. The apparatus of claim 14, wherein the attachment part is a portion of the nozzle.

16. The apparatus of claim 11, wherein the photodetector comprises a lensless scattered light collection system and an integrated beam stop.

17. The apparatus of claim 11, wherein the opening and at least another part of the nozzle are in the detection chamber.

18. The apparatus of claim 11, wherein the fixed laser is configured to produce a focused laser beam, and wherein the focused laser beam is focused along at least two axes.

19. The apparatus of claim 18, wherein the beam diameter of the focused laser beam is smaller than a width or a diameter of the opening or the stream diameter of the stream of the test fluid as the laser beam intersects the stream.

20. An apparatus, comprising:
a detection chamber;
a conduit configured to convey a test fluid to the detection chamber;
a nozzle at an end of the conduit comprising an opening and configured to eject the test fluid into the detection chamber via the opening; and
a detection system configured to monitor at least one characteristic of the test fluid when it is ejected from the opening of the nozzle, and the detection system, comprising:
a laser configured to produce a laser beam, wherein the location of the nozzle is adjustable to align the opening of the nozzle with the laser beam; and
a photodetector configured to detect light scattered from the laser beam after the beam hits a particle in the test fluid as the fluid is ejected from the opening of the nozzle.
